(19) United States
(12) Patent Application Publication
(10) Pub. No.: US 2008/0276919 A1
(43) Pub. Date: Nov. 13, 2008

(54) Piston, A Ring and a Piston Assembly for a Two Cycle Engine

(76) Inventor: Denver Stanley Porter Lawson, Drury (NZ)

Correspondence Address: WADDEY & PATTERSON, P.C., 1600 DIVISION STREET, SUITE 500, NASHVILLE, TN, 37203, US

(21) Appl. No.: 11/916,865

(22) PCT Filed: Jun. 8, 2005
(86) PCT No.: PCT/NZ2005/000119

§ 371 Date: Jul. 1, 2008

(30) Foreign Application Priority Data
Jun. 8, 2004 (NZ) 533403
Sep. 17, 2004 (NZ) 535388

(51) Int. Cl. F02F 1/22; F16J 9/02; F16J 1/00; F02F 5/00

(52) U.S. Cl. 123/65 PE; 277/446; 277/445; 277/449

(57) ABSTRACT

A piston ring (3) for a two cycle internal combustion engine has a sealing portion (4) and a piston engaging portion (5) adapted to engage with a ring engaging portion of a piston (200) to restrict radial movement of the sealing portion (5). A piston, a piston assembly and a two cycle internal combustion engine including the piston ring are also disclosed.

The present invention relates to a piston, a ring and a piston assembly for internal combustion engines, and in particular, but not exclusively, to a piston, ring and piston assembly for a two cycle engine.

### BACKGROUND ART

For many years two cycle engines, also known as two-stroke engines, have been used where high specific power outputs and/or low weight and/or low cost are required.

Current designs of two cycle engines are acknowledged to have a number of limitations.

The flow of gas into and out of a two cycle engine is controlled by the movement of the piston within the cylinder or “barrel”. In general, power output is increased as the flow through the intake, transfer and exhaust apertures or “ports” is increased.

Conventional two-stroke engines use one or two sealing rings to provide sealing between the piston and the barrel. The rings sit in substantially parallel-sided grooves in the piston, and are sized such that they must be compressed in order to fit within the cylinder. The radial expansion of the rings is controlled by the cylinder wall or “bore”.

In addition to the radial tension of the compressed ring, sealing of the rings is provided by the high pressure combustion gas acting on the top surface of the ring to push it down onto the bottom surface of the ring groove, and the pressure acting on the inside edge of the ring to push it outward towards the cylinder wall.

A factor which limits the area of the exhaust port in current two cycle designs is the tendency for the compression ring or rings to expand or “bulge” out into the exhaust port as the piston uncovers the port. Although the shape of the edge of the exhaust port may be contoured so as to ease the ring back into its groove, current designs are forced to limit the maximum width of the port over which the ring is unsupported. The need to design the port so as to ease the ring back into the ring groove may compromise the design of the port. This may be particularly undesirable in high-performance engines, where the shape of the exhaust port is critical to extracting the maximum performance from the engine.

At present, the exhaust ports of most high-performance two cycle engines may be divided into two categories, the “three port” design, in which a main exhaust port has a supplementary exhaust port at either side, and a “bridged” design in which a single exhaust port is bisected by a bridge, which essentially divides the port into two closely spaced individual ports. The sole purpose of the bridge is to provide support for the ring. Both of these designs are limited in their ability to remove the exhaust gas fast enough at high output and high engine speeds, particularly in the phase of exhaust opening prior to the transfer ports being uncovered.

In the case of the three port design, the practical maximum port width is around 75% of the bore diameter. In the case of the bridged design, the maximum width of each half of the port is around 50% of the bore diameter.

### OBJECT OF THE INVENTION

It is one object of a preferred embodiment of the invention to provide a piston assembly in which the outward radial movement of the piston ring is restricted by the piston.

It is an alternative object of a preferred embodiment of the invention to provide a piston ring and/or a piston and/or a piston assembly and/or an engine assembly, which will overcome or ameliorate problems with such apparatus at present, or which will at least provide the public with a useful choice.

### DISCLOSURE OF THE INVENTION

According to one aspect of the present invention there is provided a piston ring for a two cycle internal combustion engine, the piston ring including a sealing portion and a piston engaging portion adapted to, in use, engage with a ring engaging portion of a piston to restrict radial movement of said sealing portion when in use.

Preferably, said sealing portion of said piston ring may be adapted to, in use, extend substantially transversely to an inner wall of a cylinder of said internal combustion engine, and said piston engaging portion of said piston ring may extend at an angle to said sealing portion.

Preferably, said angle between said sealing portion and said piston engaging portion may be substantially 90°.

Preferably, said piston ring may be substantially “L” shape in cross-section.

According to a second aspect of the present invention there is provided a piston ring for a two cycle internal combustion engine, the piston ring having two ends, each said end provided with a slot or aperture adapted to, in use, engage a projecting portion of a piston to thereby substantially prevent lateral movement of said ends.

According to a third aspect of the present invention there is provided a piston ring for a two cycle internal combustion engine, the piston ring including a projecting portion adapted to, in use, engage a piston ring engaging recess in a piston, to thereby substantially limit movement of said ring in a direction radial to a central axis of said piston.

According to a fourth aspect of the present invention there is provided a piston for a two cycle internal combustion engine adapted to engage a piston ring as described in any of the six immediately preceding paragraphs.

Preferably, said piston may include a body and a separate crown adapted to engage said body.

Preferably, said body of said piston may be adapted to engage said piston engaging portion of said piston ring.

Preferably, said crown may be adapted to detachably engage said body.

Preferably, said piston may include a ring groove with a substantially “L” shaped cross-section.

According to a further aspect of the present invention there is provided a piston assembly for a two cycle internal combustion engine including the piston of any one of the four immediately preceding paragraphs in combination with a suitable piston ring.

According to a still further aspect of the present invention there is provided a two cycle internal combustion engine assembly including at least one cylinder having an inlet aperture, an exhaust aperture, and at least one piston assembly as described in the immediately preceding paragraph moveable within the cylinder, wherein a width of said exhaust aperture is between substantially 75% and 100% of said bore diameter and said exhaust aperture does not include a bridge.

Preferably, said width of said exhaust aperture may be between substantially 80% and 100% of said diameter of said cylinder.

Preferably, said width of said exhaust aperture may be between substantially 90% and 100% of said diameter of said cylinder.

Preferably, said width of said exhaust aperture may be substantially equal to said diameter of said cylinder.

According to a still further aspect of the present invention, a piston ring and/or a piston and/or an engine assembly is substantially as herein described with reference to the accompanying drawings.

Further aspects of the invention, which should be considered in all its novel aspects, will become apparent from the following description given by way of example of possible embodiments of the invention.

### BRIEF DESCRIPTION OF THE FIGURES

FIG. 1a: Is a front view of a piston according to one possible embodiment of the present invention, with a threaded portion joining the piston body and piston crown, and the little end boss, shown in hidden detail.

FIG. 1b. Is a side view of the piston of FIG. 1a.

FIG. 1c: Is a back view of the piston of FIG. 1a.

FIG. 1d: Is a bottom view of the piston of FIG. 1a.

FIG. 2a: Is a plan view of a piston ring according to one possible embodiment of the present invention.

FIG. 2b: Is an enlarged plan view of detail C of FIG. 2a, showing the ends of the piston ring.

FIG. 2c: Is a cross section of the piston ring of FIG. 2a through A-A.

FIG. 2d: Is an enlarged view of detail B of FIG. 2c, showing a side view of one end of the ring.

FIG. 3a: Is a cross-section side view of the piston of FIGS. 1a-d, with the piston ring removed for clarity.

FIG. 3b: Is an enlarged view of detail B of FIG. 3a, showing the ring groove and the ring location pin.

FIG. 4: Is an exploded view of a piston assembly according to one embodiment of the present invention, including the piston of FIGS. 1a-d and the piston ring of FIGS. 2a-d.

FIG. 5a: Is a cross-section side view of the piston of FIGS. 1a-d, with a piston ring installed.

FIG. 5b: Is an enlarged view of detail B of FIG. 5a, showing the installed piston ring.

FIG. 5c: Is a cross-section side view of an alternative embodiment of the piston assembly with the piston ring in an inverted orientation.

FIG. 5d: Is an enlarged view of detail C of FIG. 5c, showing the installed piston ring.

FIG. 6: Is a rear view cross section through a two cycle engine barrel and piston according to one possible embodiment of the present invention

FIG. 7a: Is a plan perspective view of a piston assembly according to another possible embodiment of the present invention, with the crown of the piston removed for clarity.

FIG. 7b: is an enlarged view of detail A of FIG. 7a.

### BEST MODES FOR PERFORMING THE INVENTION

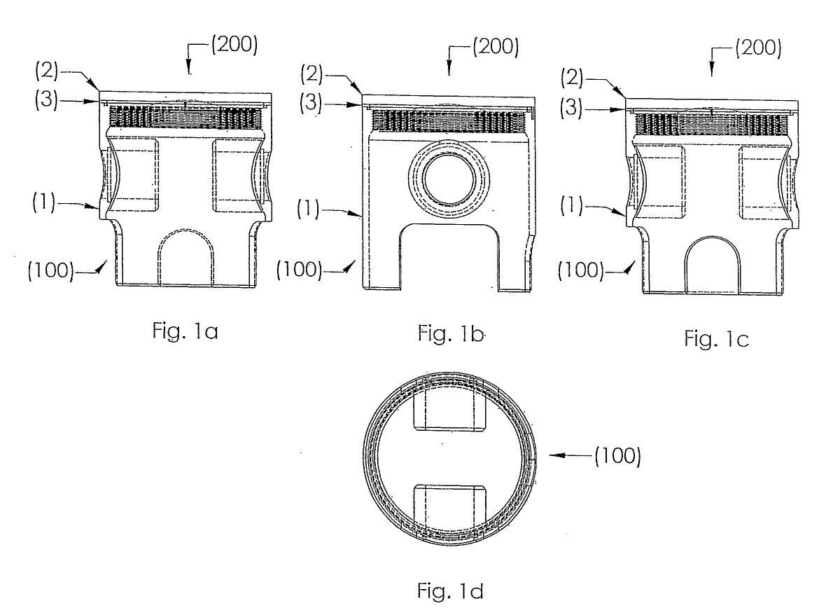

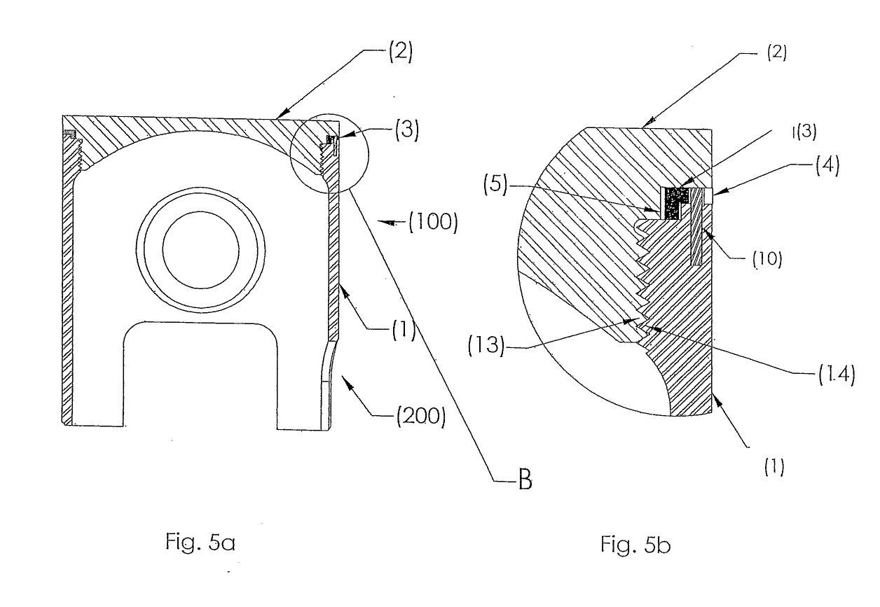

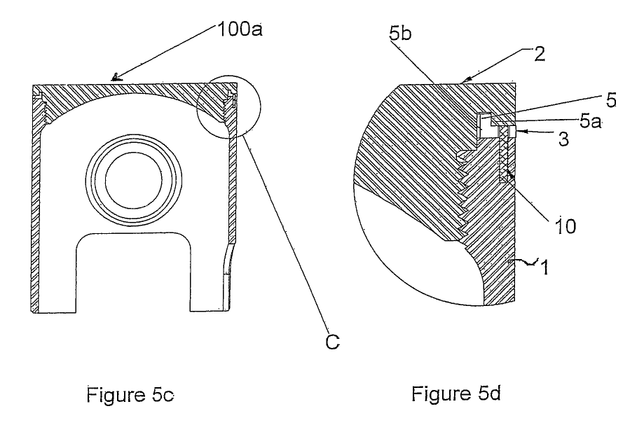

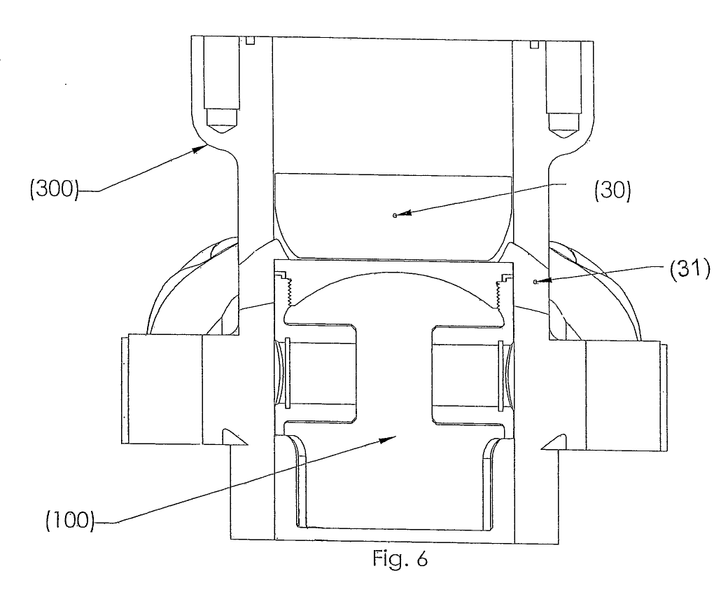

Referring first to FIGS. 1a-d, FIG. 4 and FIGS. 5a and 5b, a piston assembly for a two cycle internal combustion engine according to one embodiment of the present invention is generally referenced 100. The assembly 100 includes a piston 200 having a body 1 and a removable crown 2 in combination with a piston ring 3.

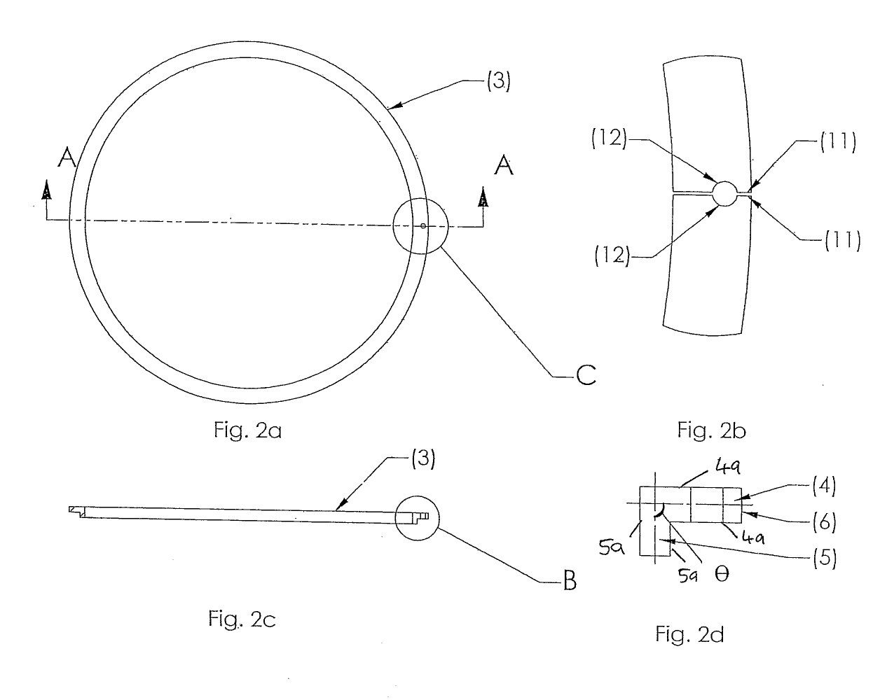

Referring next to FIGS. 2a-2d, the piston ring 3 includes a sealing portion 4 and a piston engaging portion 5. In a preferred embodiment the piston engaging portion 5 may be a substantially cylindrical flange. The ring 3 will typically be split as is normal for a sealing ring in an internal combustion engine.

The sealing portion 4 may have substantially the same sealing face 6 as a conventional two cycle internal combustion engine sealing ring. Any suitable profile may be used at the sealing face 6.

The sealing portion 4 is adapted to extend substantially transversely to the surface of the cylinder bore when in use, as is typical of conventional two cycle sealing rings. The piston engaging portion 5 forms an angle Θ with the sealing portion 4 so as to engage with an engaging portion of the piston 200, as is described further below.

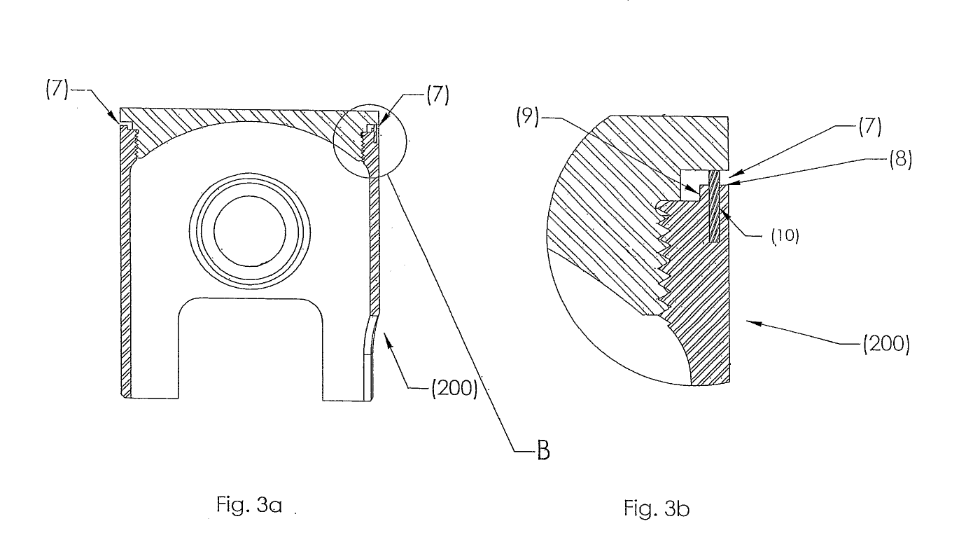

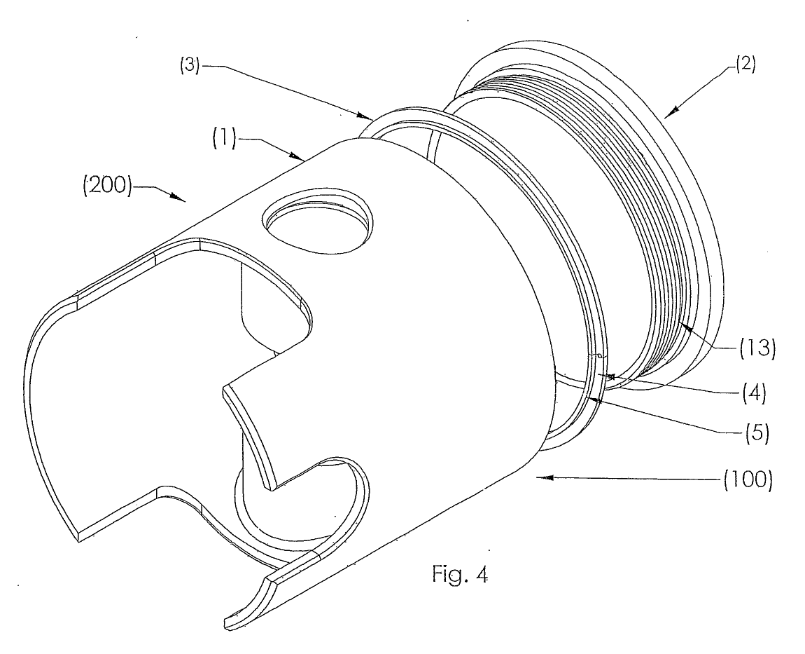

Referring next to FIGS. 3a-b and 5a-b, the piston 200 has a ring groove 7 adapted to engage the ring 3. The ring groove 7 includes a sealing portion 8 and a ring engaging portion 9 adapted to restrict outward radial movement or expansion of the ring 3. In a preferred embodiment the ring engaging portion 9 is a substantially annular recess provided in the body 1.

Preferably the angle between the sealing portion 8 and the engaging portion 9 is substantially equal to the angle Θ formed between the sealing portion 4 and the piston engaging portion 5 of the ring 3. In a particularly preferred embodiment the angle Θ is substantially 90° so that both the ring 3 and the ring groove 7 form a substantially “L” shape cross section. In a preferred embodiment the sides 4a of the sealing portion 4 and the sides 5a of engaging portion 5 of the ring 3 are substantially parallel, that is, the sides do not taper. Values of angle Θ other than 90° may also be used however, and in another embodiment the piston engaging portion 5 may be any suitable alternative shape, for example substantially curved.

Referring to FIG. 5a-b, the piston 200 may include a ring location pin 10 which may preferably be pressed into a suitable aperture in the body 1 of the piston. The ring 3 may be installed into the piston such that the ends 11 of the ring 3, best seen in FIG. 2b, are on either side of the ring location pin 10. In this way the ring 3 may be prevented from rotating, which could result in the ends 11 rotating into an unfavourable position in the bore in relation to the ports. In a preferred embodiment the ends 11 may have cutouts 12, allowing a required gap to be provided when installed.

Referring next to FIGS. 1a-d, FIG. 4 and FIG. 5b, in a preferred embodiment the crown 2 is connectable to the body 1 by means of a thread 13 which engages a complementary thread 14 provided inside the piston body 1. Other suitable means of engaging a piston crown 2 with a piston body 1 may be used, for example an interference fit and pin locator between the crown 2 and piston body 1.

The ring 3 is preferably installed with the piston crown 2 separated from the body 1. In some embodiments the crown 2 may not need to be removable subsequent to the ring 3 being installed, and so the engagement between the body 1 and the crown 2 may be substantially permanent.

Referring next to FIGS. 5c and 5d, an alternative embodiment of the piston assembly is generally referenced 100a. In this embodiment the ring 3 may be installed such that the piston engaging portion 5 engages the piston crown 2 rather than the body 1. The ring engaging portion of the crown 2 may be an annular recess.

This embodiment may be easier to manufacture than the embodiment illustrated in FIGS. 5a and 5b but may have other disadvantages.

A ring location pin 10 may still be used and may be engaged with the piston body 1.

In some embodiments with the piston ring 3 in the orientation shown in FIGS. 5c and 5d, the pressure of the combustion gas impinging on the outer surface 5a of the piston engaging portion 5 may tend to force the ring 3 radially inward before the pressure around the piston engaging portion 5 equalises. To overcome this, the piston crown 2 may be provided with one or more ports (not shown) adapted to allow the pressure of the combustion gas to act on the inner surface 5b of the piston engaging portion 5, thereby creating a radially outward force on the piston engaging portion 5 or at least speeding the equalisation of pressure on both sides of the piston engaging portion 5.

Referring next to FIG. 6, a two cycle internal combustion engine according to a possible embodiment of the present invention may include an inlet aperture 31, which may also be known to those skilled in the art as a transfer port. The engine further includes a piston assembly 100 and exhaust aperture or port 30. In a preferred embodiment the piston assembly 100 is provided with a single ring 3 in order to minimise friction between the ring 3 and the walls of the barrel 300.

By utilising a piston assembly 100 of the present invention, movement of the ring 3 in a direction radial to the central axis of the piston is restricted or substantially eliminated. This may allow a two cycle engine barrel 300 to have an exhaust port 30 with a width of greater than 75% of the barrel diameter, without requiring a bridge. In a preferred embodiment the width of the exhaust port 30 may be between 80% and 100% of the barrel diameter, or more preferably between 90% and 100% of the barrel diameter, or more preferably still the width of the port 30 may be substantially equal to the diameter of the barrel 300 without the use of a bridge.

Increasing the width of the port 30 over the designs of the prior art may allow a reduction in the height of the port 30 for a given area, resulting in a higher port velocity. This may substantially reduce backflow along the port floor. The port 30 may also provide an increased flow in the blowdown phase compared to known exhaust ports. Those skilled in the art will appreciate that these factors may contribute to an increase in power from a two cycle engine having such a port 30.

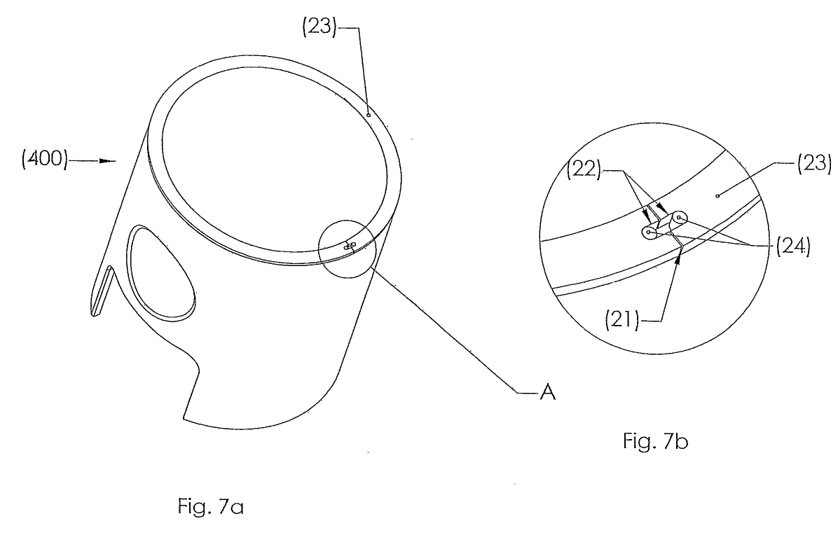

Referring next to FIGS. 7a and 7b, in a further possible embodiment of the invention the ring 23 may have a substantially conventional flat cross-section, rather than the substantially “L” shaped cross-section of the embodiment described above. The ring 23 may be provided with piston engaging cutouts 22 at the ends 21.

The piston 400 may be provided with a pair of spaced apart piston ring engaging pins 24, which project from the ring groove. Preferably the space between the pins 24 may be in the order of 2 mm for a piston of 54 mm diameter. Correct spacing of these pins would be known by those skilled in the art of two stroke piston design.

The ring 23 is installed with the cutouts 24 engaging the piston ring engaging pins 24. The cutouts 22 are preferably deep enough that a required gap can be provided between the ends 21 of the ring 23.

The cutouts 22 in the ring 23 may be sized such that the ring 23 is able to maintain contact with the cylinder wall under all engine operating conditions, but the ring ends are unable to bulge out into the exhaust port 30 to an extent that would cause ring and/or engine damage. The pins 24 are preferably orientated on the side of the piston 400 which passes over the exhaust aperture (not shown). The pins 24 hold the ends 21 and substantially restrict radial movement of the ends, thereby preventing the ends 21 and the adjacent portion of the ring 23 from expanding or “bulging” into the exhaust aperture.

The pins 24 are preferably provided on the side of the piston 400 which passes over the exhaust aperture (not shown).

In a still further embodiment of the invention (not shown) the ends of the piston ring may be provided with apertures therethrough in place of the cutouts described above.

Those skilled in the art will appreciate that by using a piston and piston ring of the present invention, an engine designer may design an engine with one or more exhaust ports having a required shape and width, without the necessity of providing a bridging portion or supplementary exhaust ports to prevent the compression ring from extending or moving into the exhaust port. By removing the requirement for a bridge, the flow through the exhaust port may be improved with a consequent increase in performance. Additionally, the transfer ports may be designed to have no bridging portion between adjacent ports so that an increase of scavenging efficiency is possible due to the elimination of “dead spots” in the area of discharge where exhaust gas can dilute the incoming charge

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the spirit or scope of the appended claims.

1. A piston ring for a two cycle internal combustion engine, the piston ring including a sealing portion and a piston engaging portion adapted to, in use, engage with a ring engaging portion of a piston to restrict radial movement of said sealing portion when in use.

2. The piston ring of claim 1 wherein the sealing portion of said piston ring is adapted to, in use, extend substantially transversely to an inner wall of a cylinder of said internal combustion engine, and said piston engaging portion of said piston ring extends at an angle to said sealing portion.

3. The piston ring of claim 2 wherein said angle between said sealing portion and said piston engaging portion is substantially 90°.

4. The piston ring of claim 2 wherein said piston ring is substantially “L” shape in cross-section.

5. A piston ring having two ends, each said end provided with a slot or aperture adapted to, in use, engage a projecting portion of a piston to thereby substantially prevent lateral movement of said ends.

6. A piston ring including a projecting portion adapted to, in use, engage a piston ring engaging recess in a piston, to thereby substantially limit movement of said ring in a direction radial to a central axis of said piston.

7. A piston for a two cycle internal combustion engine adapted to engage the piston ring of claim 1.

8. The piston of claim 7 including a body and a separate crown adapted to engage said body.

9. The piston of claim 8 wherein said body of said piston is adapted to engage said piston engaging portion of said piston ring.

10. The piston of claim 8 wherein said crown is adapted to detachably engage said body.

11. The piston of claim 7 including a ring groove with a substantially “L” shaped cross-section.

12. A piston assembly for a two cycle internal combustion engine including the piston of claim 7 in combination with a suitable piston ring.

13. A two cycle internal combustion engine assembly including at least one cylinder having an inlet aperture, an exhaust aperture, and at least one piston assembly as claimed in claim 12 moveable within the cylinder, wherein a width of said exhaust aperture is between substantially 75% and 100% of a diameter of said cylinder and said exhaust aperture does not include a bridge.

14. The two cycle engine of claim 13 wherein said width of said exhaust aperture is between substantially 80% and 100% of said diameter of said cylinder.

15. The two cycle engine of claim 14 wherein said width of said exhaust aperture is between substantially 90% and 100% of said diameter of said cylinder.

16. The two cycle engine of claim 15 wherein said width of said exhaust aperture is substantially equal to said diameter of said cylinder.

17. (canceled)

18. (canceled)

19. (canceled)
